(19) United States
(12) Patent Application Publication
(10) Pub. No.: US 2007/0180027 A1
(43) Pub. Date: Aug. 2, 2007

(54) Computerized news preparatory service

(75) Inventor: Christopher Boylan, Fayetteville, NC (US)

Correspondence Address: ROBERT PLOTKIN, PC, 45 BUTTERMUT CIRCLE, CONCORD, MA, 01742-1937, US

(73) Assignee: Rock Hammer Media, LLC

(21) Appl. No.: 11/327,101

(22) Filed: Jan. 6, 2006

(51) Int. Cl. G06F 15/16

(52) U.S. Cl. 709/204

(57) ABSTRACT

Techniques are disclosed herein for including news stories in radio shows and, more generally, for including content in online publications. For example, a user may submit content (such as a news story displayed in a web page) for possible inclusion in a radio talk show by performing a single action (such as clicking on a bookmarklet). Multiple users may submit multiple units of content for possible inclusion in the show in this way. Each user may review stories submitted by all users. If a user considers particular content to worthy of further consideration, he or she may flag (“prep”) that content for further consideration. The user may review the content that he or she has “prepped,” and flag (“mint”) individual units of content for inclusion in the radio show. Minted content is added automatically to a web page associated with the user and/or show.

### BACKGROUND

1. Field of the Invention

The present invention relates to communication using computer networks and, more particularly, to online news publishing.

2. Related Art

Radio talk shows have long made use of third-party “prep services” (where “prep” is short for “preparatory”) to provide them with frequent updates about the most current news. For example, a prep service may send a particular radio show an email message every morning containing summaries of the top stories from the previous day. This provides the radio show producer, hosts, and others involved in the radio show with the opportunity to select stories to cover on the show that day. Some prep services have made it possible for their subscribers to view “the prep” (the collection of stories and news that is delivered by a prep service) using a secure web page, instead of or in addition to by email.

Prep services can be helpful because they reduce the amount of research and other preparation that must be performed by members of the radio show. But existing prep services may not fulfill all of the preparatory needs of their subscribers. For example, a prep service may not correctly anticipate all of the recent stories that are of interest to members of a particular radio show. As a result, the prep on a particular day may fail to include stories that members of the show want to cover on the show.

Currently, if a member of a show finds a story of interest—such as by reading about it in a newspaper or on a web site—that is not covered by the show's existing prep service(s), the member must typically manually distribute that story (such as by email or hardcopy) to other members of the show. In this and other situations, it can be difficult to integrate stories provided by prep services with stories found by members of the show into the show itself. Similar problems may arise not only in the production of radio shows, but in the production of television shows and other electronic media, and in the production of web sites and other kinds of publications.

What is needed, therefore, are improved techniques for integrating content into electronic communications.

### SUMMARY

Techniques are disclosed herein for including news stories in radio shows and, more generally, for including content in online publications. For example, a user may submit content (such as a news story displayed in a web page) for possible inclusion in a radio talk show by performing a single action (such as clicking on a bookmarklet). Multiple users may submit multiple units of content for possible inclusion in the show in this way. Each user may review stories submitted by all users. If a user considers particular content to worthy of further consideration, he or she may flag (“prep”) that content for further consideration. The user may review the content that he or she has “prepped” for inclusion into the radio show and flag (“mint”) individual units of content for inclusion in the radio show. Minted content is added automatically to a web page associated with the user and/or show.

For example, one embodiment of the present invention is directed to a computer-implemented method which includes: (A) receiving an indication of a single action performed by a first user to identify an electronic document; and (B) in response to receiving the indication of the single action, storing information derived from the electronic document in a document repository.

Another embodiment of the present invention is directed to a computer-implemented method which includes: (A) receiving an indication of a single action performed by a first user to identify an electronic document; and (B) in response to receiving the indication of the single action, generating a first web page including information derived from the electronic document.

Yet another embodiment of the present invention is directed to a computer-implemented method which includes (A) receiving an input from a first user to identify content in a source web page; (B) in response to receiving the input, storing the identified web page content in a document repository; and (C) making the identified web page content accessible at an Internet address.

A further embodiment of the present invention is directed to a computer-implemented method which includes: (A) making a content unit available to a plurality of users over a computer network, the content unit including shared content, first private content for a first one of the plurality of users, and second private content for a second one of the plurality of users; (B) receiving first input from the first one of the plurality of users, the first input indicating a modification to the first private content; (C) modifying the first private content in response to the first input; (D) receiving second input from the second one of the plurality of users requesting access to the content unit; and (E) in response to the second input, providing the second user with access to the shared content and the second private content but not the first private content.

Yet a further embodiment of the present invention is directed to a computer-implemented method which includes: (A) making a content unit available to a plurality of users over a computer network, the content unit including shared content and non-shared content; (B) receiving first input from the first one of the plurality of users, the first input indicating a first modification to the non-shared content; (C) in response to the first input: (C) (1) copying the non-shared content to produce first private content; and (C) (2) modifying the first private content; (D) receiving second input from the second one of the plurality of users requesting access the content unit; and (E) in response to the second input, providing the second user with access to the shared content and the non-shared content but not the first private content.

Other features and advantages of various aspects and embodiments of the present invention will become apparent from the following description and from the claims.

### BRIEF DESCRIPTION OF THE DRAWINGS

FIGS. 1A-1C are data flow diagrams of a publishing system according to one embodiment of the present invention;

FIG. 2 is a flowchart of a method that is performed by the system of FIGS. 1A-1C according to one embodiment of the present invention;

FIG. 3A is an illustration of a web page containing content that a user of the system of FIGS. 1A-1C may submit for potential inclusion in an electronic communication according to one embodiment of the present invention;

FIG. 3B is an illustration of a web page through which the system of FIGS. 1A-1C allows a user to edit content extracted from the web page of FIG. 3A according to one embodiment of the present invention;

FIG. 3C is an illustration of a web page displaying content extracted from the web page of FIG. 3A according to one embodiment of the present invention;

FIG. 3D is an illustration of a web page displaying content that has been “prepped” by a user of the system of FIGS. 1A-1C according to one embodiment of the present invention;

FIG. 3E is an illustration of a web page displaying the source of a “prepped” story according to one embodiment of the present invention;

FIG. 3F is an illustration of a web page displaying content that has been “minted” by a user of the system of FIGS. 1A-1C according to one embodiment of the present invention;

FIG. 3G shows an XML file representing a list of “minted” news stories according to one embodiment of the present invention;

FIG. 3H shows an HTML file representing a list of “minted” news stories according to one embodiment of the present invention;

FIG. 3I shows an HTML file containing AJAX code for requesting a list of “minted” news stories according to one embodiment of the present invention; and

FIG. 3J shows a web page containing hyperlinked summaries of “minted” news stories, in addition to other content, according to one embodiment of the present invention.

### DETAILED DESCRIPTION

Techniques are disclosed herein for including news stories in radio shows and, more generally, for including content in online publications. For example, a user may submit content (such as a news story displayed in a web page) for possible inclusion in a radio talk show by performing a single action (such as clicking on a bookmarklet). The user may, for example, be a listener of the show or a member of the show (such as its host or producer). Multiple users may submit multiple units of content for possible inclusion in the show in this way.

Members of the radio talk show (such as its host or producer) may be provided with the ability to review content that has been submitted for possible inclusion in the show. If a member identifies particular content (such as a particular news story) that he or she deems worthy of further consideration, the member may flag the content for further consideration (i.e., “prep” the content). Any such “prepped” content then becomes available for further review by that member. Each member of the show may thereby build his or her own list of prepped content. As described in more detail below, each user may contribute to a personal prepped list or to a list that is shared by multiple users, such as a prepped list for the entire radio talk show.

Each member may view his or her own list of prepped content, or the prepped content list for his or her show. If a member identifies a unit of content (such as a particular news story) that he or she desires to publish (e.g., by including it in the talk show and/or on the member's web site), the member may flag the unit of content for publication (i.e., “mint” the content). Any such “minted” content may be published automatically on a web site associated with the user and/or show.

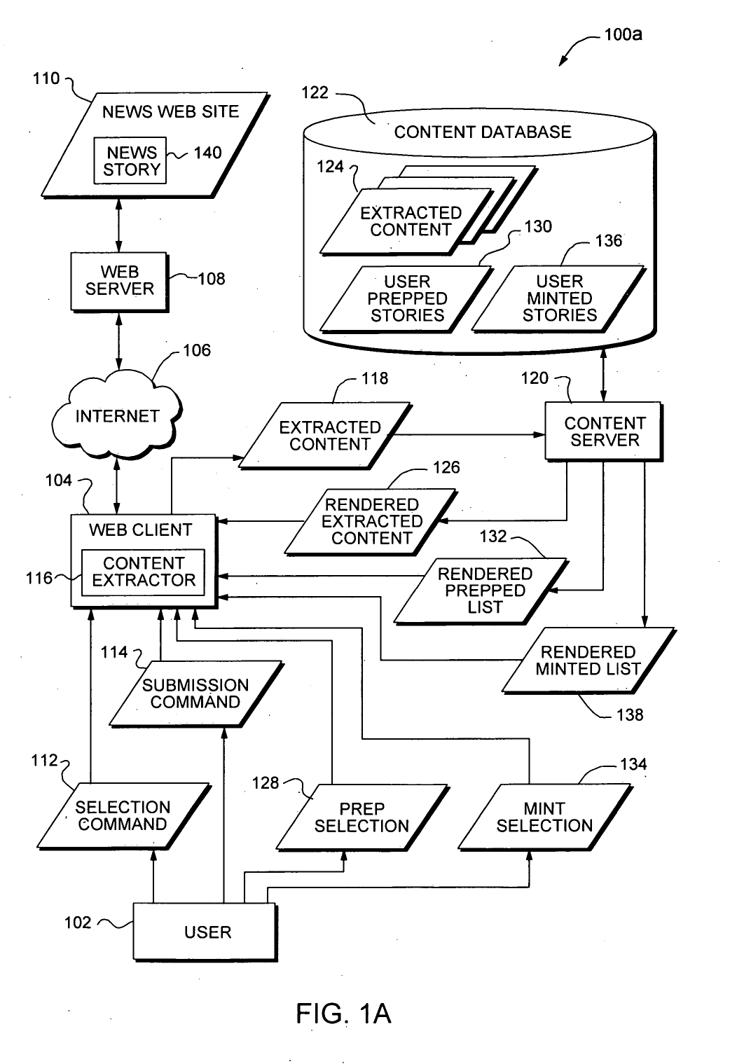

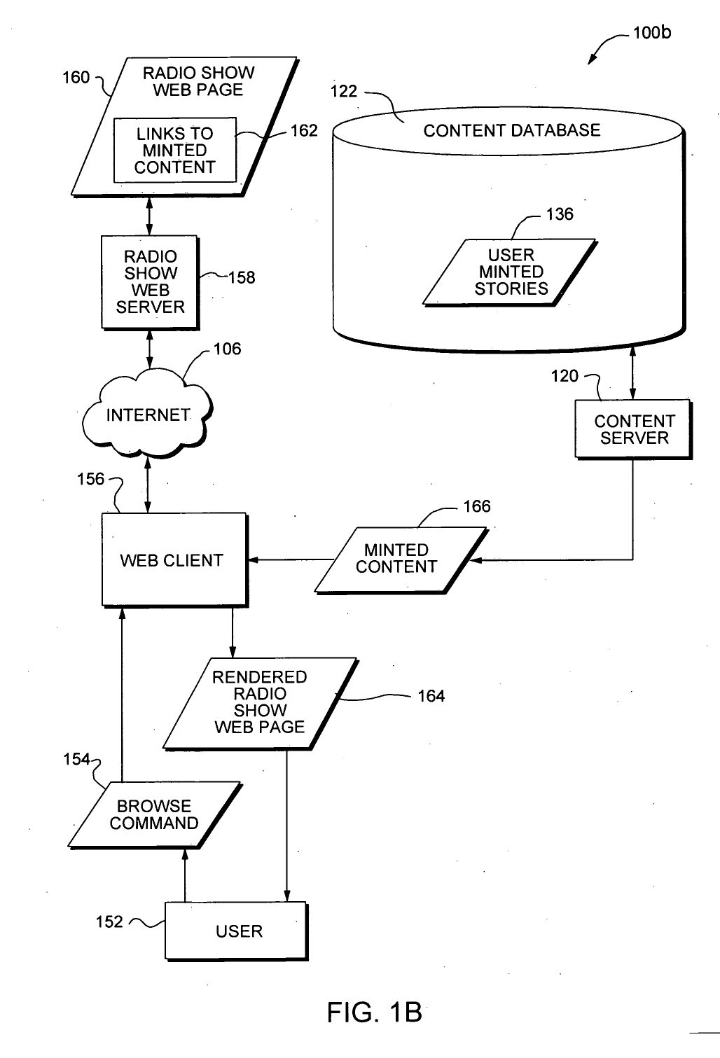

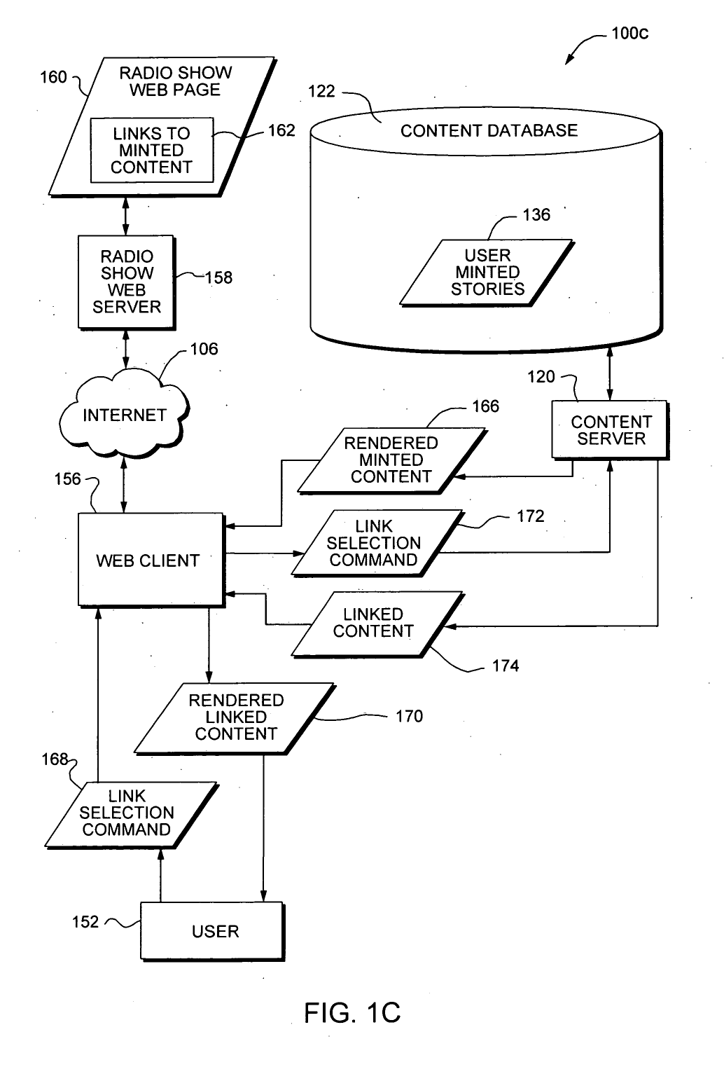

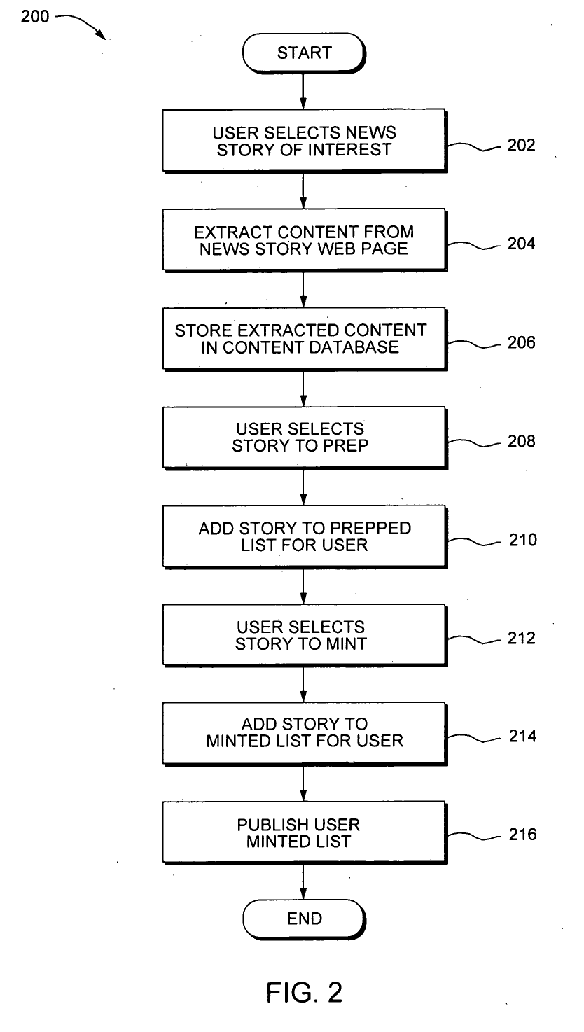

Having described aspects of the invention in general terms, particular embodiments of the present invention will now be described in more detail. Referring to FIG. 1A, a data flow diagram is shown of a publishing system 100a according to one embodiment of the present invention. The various embodiments 100a-c of the publishing system shown in FIGS. 1A-1C will be referred to collectively herein as the publishing system 100. Each of FIGS. 1A-1C illustrates a different aspect of the system 100. Referring to FIG. 2, a flowchart is shown of a method that is performed by the system 100 of FIG. 1A according to one embodiment of the present invention.

In general, the aspect of the system 10a shown in FIG. 1A illustrates the process of submitting content to the system 100a and of using the system 100a to publish such content to a web site. A user 102 of the system 100 uses a web client 104 to view a web page 110 served by a web server 108 over the Internet 106. Techniques for implementing and using web clients and servers to browse web sites are well-known to those having ordinary skill in the art and will therefore not be described herein in detail. For purposes of simplicity, certain elements of the system, such as the web client 104 and web server 108, are shown as individual functional blocks, even though such elements may take any of a variety of forms. For example, the web client 104 make be implemented using web browser software executing on a computer. Similarly, the network indicated as the Internet 106 in FIG. 1A may include any network or combination of networks, such as a corporate intranet, or any combination of public and private networks.

The user 102 may use the web client 104 to browse web sites accessible over the Internet 106. In the example illustrated in FIG. 1A, the user 102 has used the web client 104 to browse to a particular web page 110, which may be part of a web site having many pages. For purposes of this example, the web page 110 is depicted in FIG. 1A as a “news” web page to indicate that it contains a news story 140. Note, however, that more generally the web page 110 may contain any kind of content that may be of interest to the user 102.

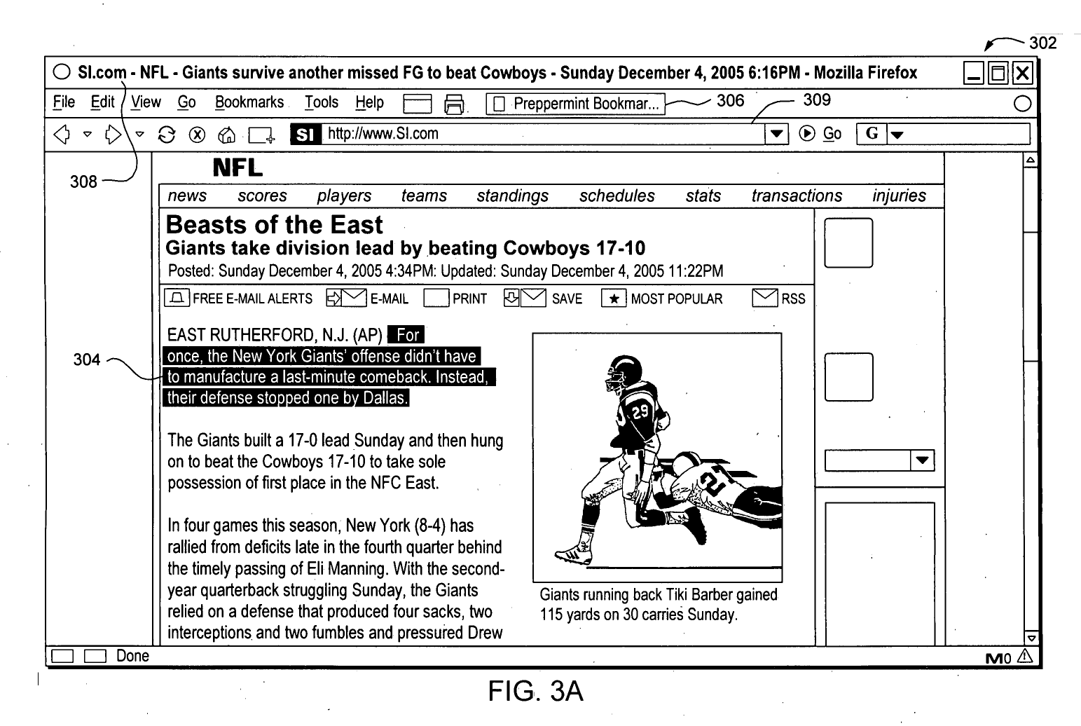

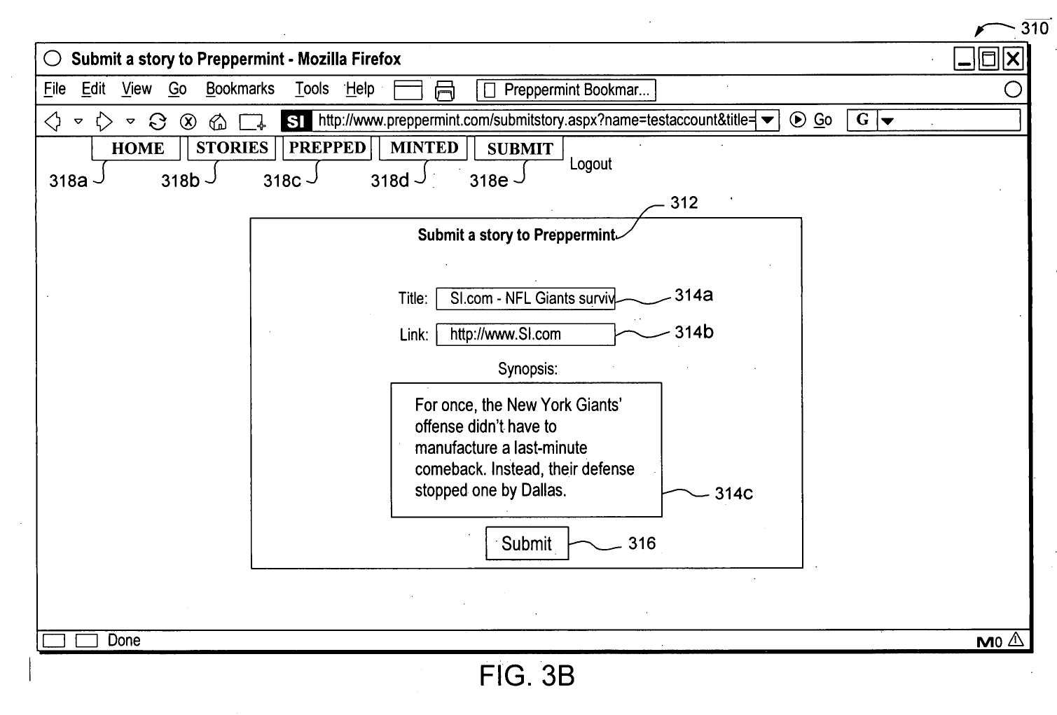

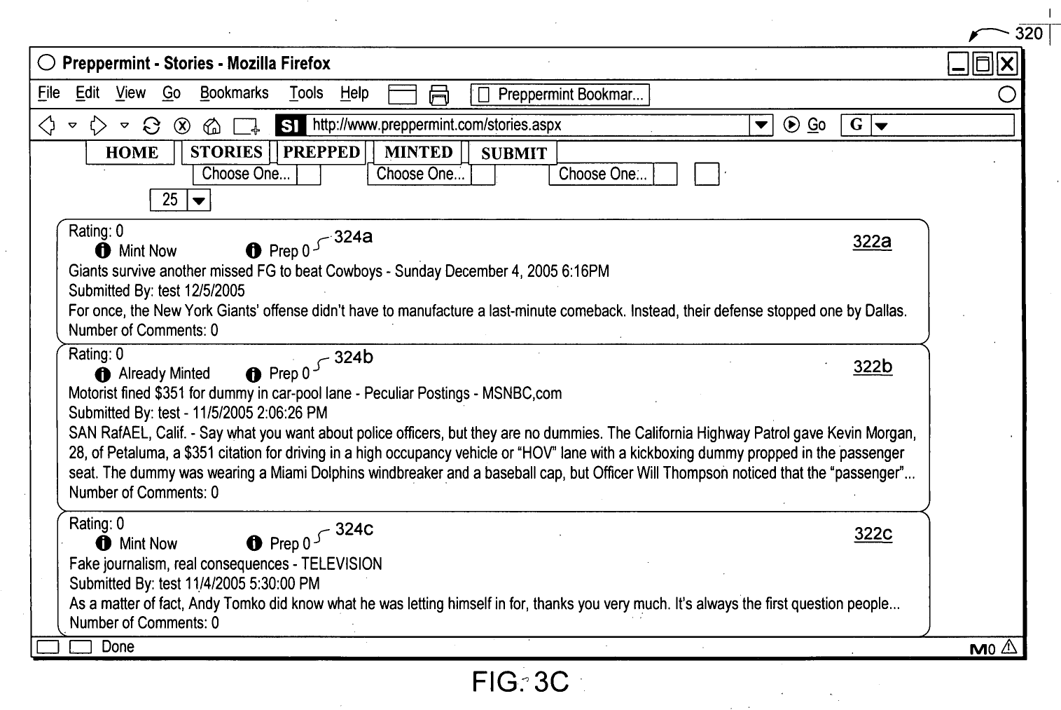

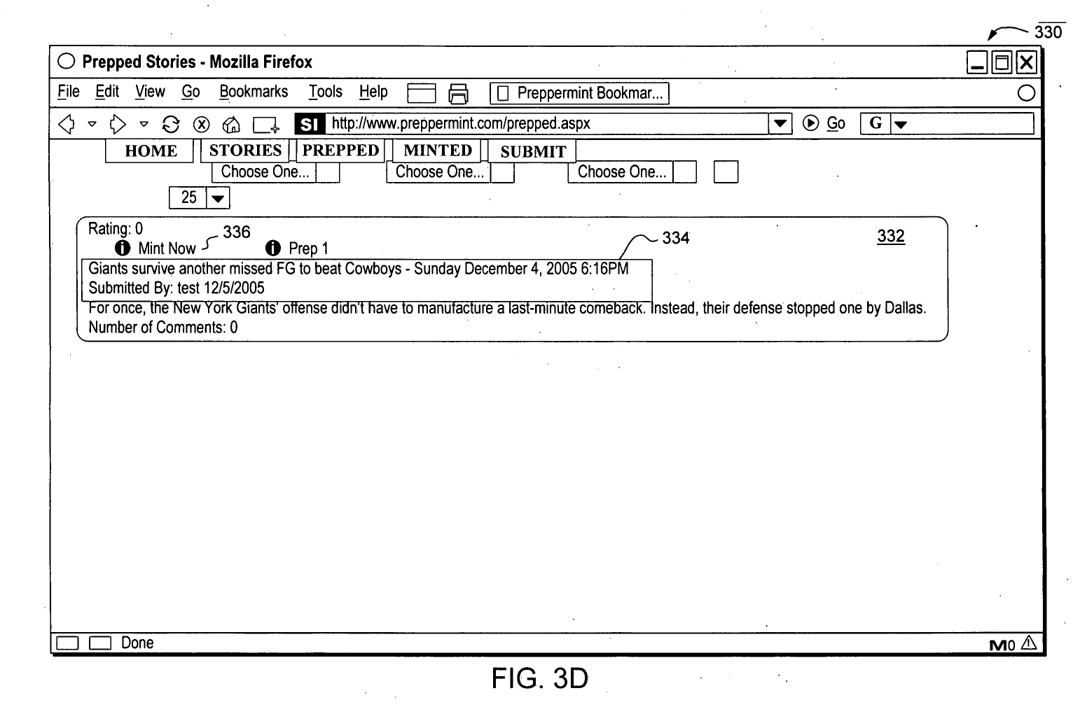

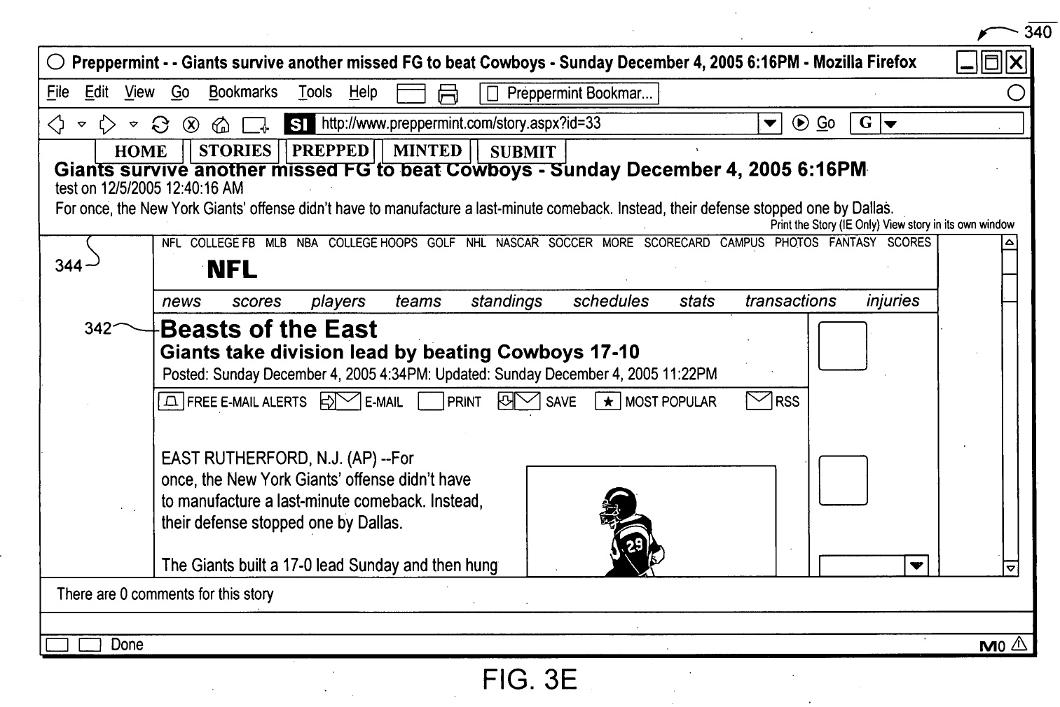

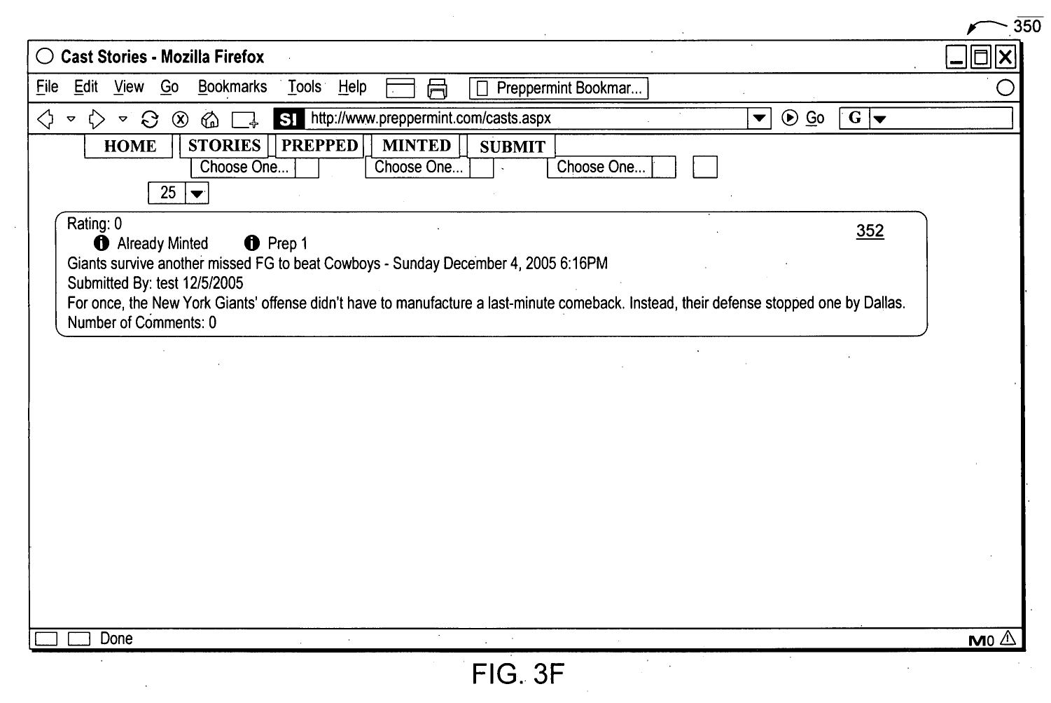

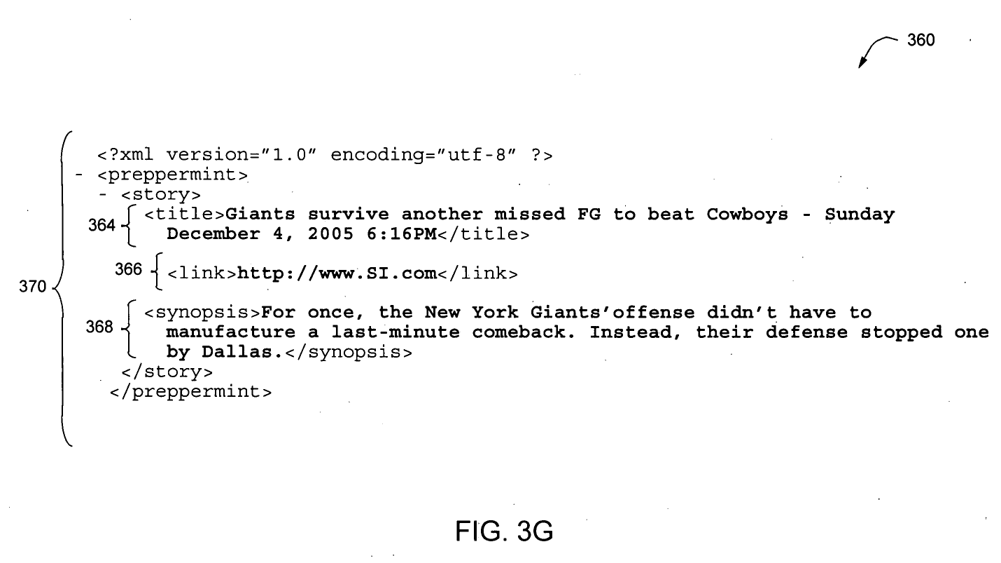

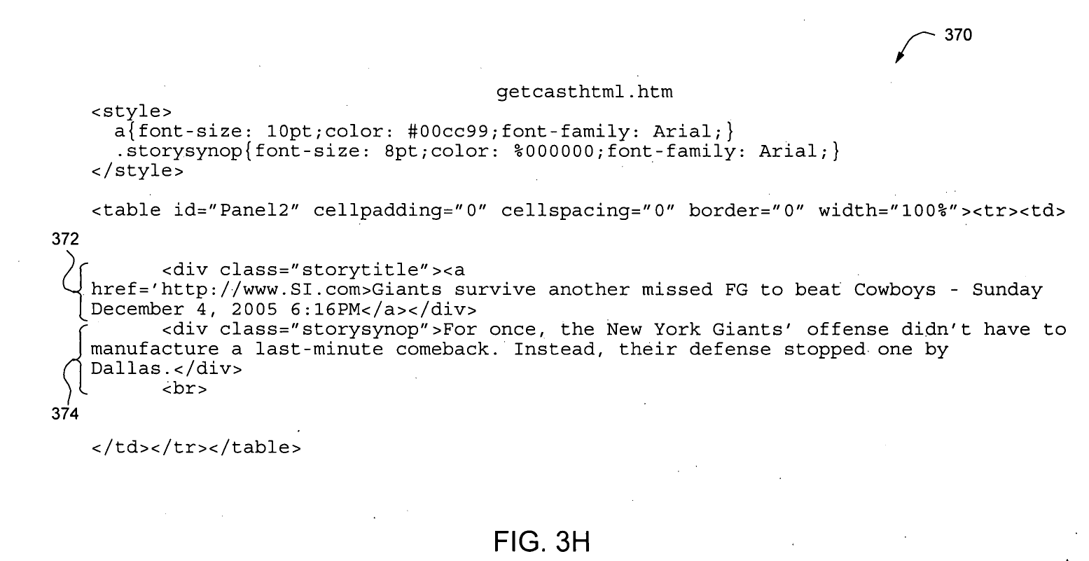

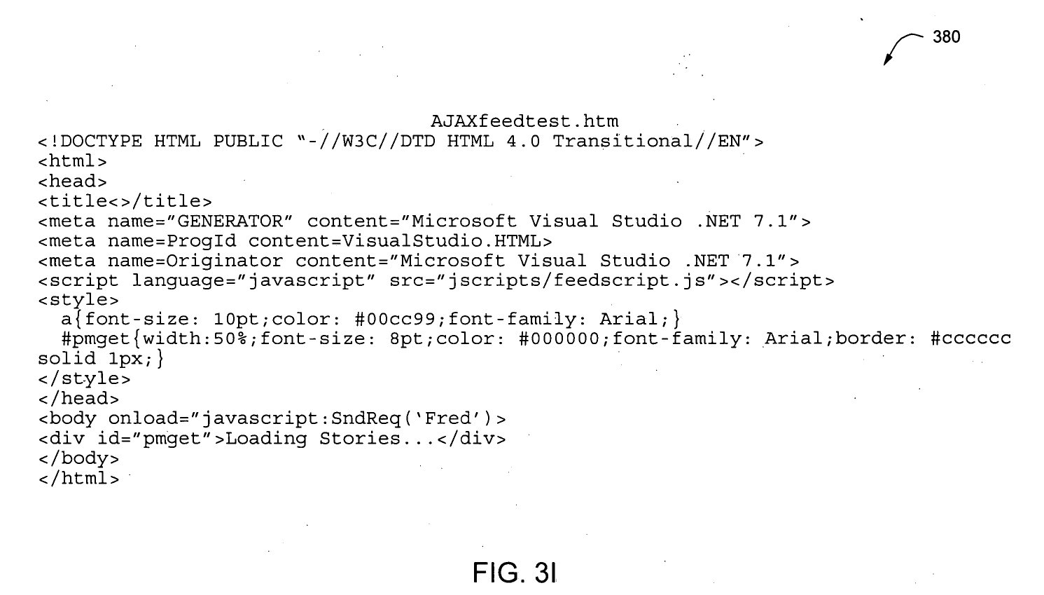

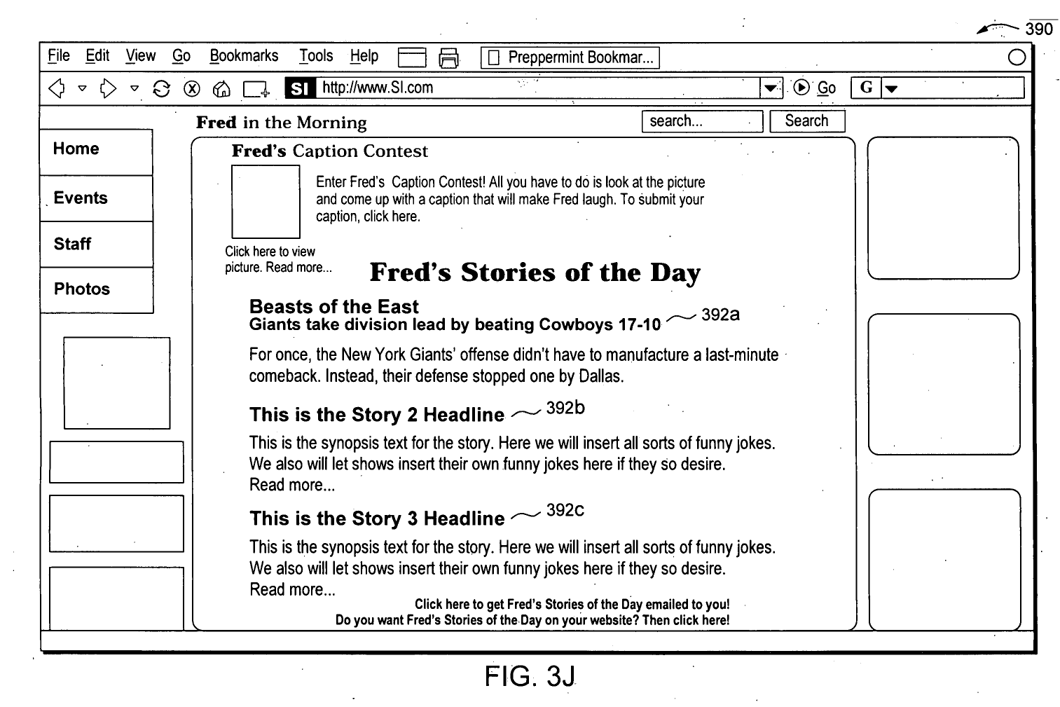

The web page 110 may be represented using a format such as HTML (Hypertext Markup Language). When the user 102 uses the web client 104 to browse to the web page 110, the web client 104 may render the web page 110 to produce a visual representation of the web page 110, including text and/or graphics. Referring to FIG. 3A, an example of a rendering 302 of the web page 110 is shown. As shown in FIG. 3A, the rendering 302 displays a sports-related news story.

If the user 102 considers any content (e.g., the news story 140) in the web page 110 to be of interest, the user 102 may select the content as content of interest (FIG. 2, step 202). The user 102 may select the content in any of a variety of ways. For example, referring to FIG. 3A, note that the user 102 has selected certain text 304 in the rendered web page 302. The user 102 may select the text 304 by providing a selection command 112 to the web client 104, such as by using a mouse to drag a text cursor over the text 304.

The user 102 may then provide a submission command 114 to the web client 104 to indicate that the user 102 wishes to submit the news web page 110 (or content derived from it) to a publisher. The term “extracted content” is used herein to refer to any content, such as the news story 140, that is contained in and/or derived from the news web page 110 and submitted to the publisher for consideration.

In one embodiment of the present invention, the user 102 provides the submission command 114 by selecting (e.g., clicking on) a bookmarklet icon 306 displayed by the web client 104. A bookmarklet is a small JavaScript program that can be stored in most web browsers in a bookmark referenced by a URL, or within a hyperlink on a web page. Selecting the bookmarklet (such as by clicking on it) causes the associated JavaScript to execute. In the present embodiment, the bookmarklet represented by the bookmarklet icon 306 contains code for submitting the selected content to a publisher. Note that although in FIG. 3A the bookmarklet icon 306 is displayed in a toolbar, the bookmarklet may be displayed in other locations, such as in a dropdown menu. The bookmarklet may be selectable in other ways, such as by pressing a hotkey. Those having ordinary skill in the art will understand how to write appropriate bookmarklet code for transmitting extracted content 118 to the publisher.

Note that although the extracted content 118 is shown for ease of illustration in FIG. 1A as being transmitted directly from the web client 104 to the content server 120, the extracted content 118 is transmitted through the Internet 106. The same is true of other information illustrated in FIG. 1A as being transmitted directly between the web client 104 and content server 120.

The user 102 may desire to transmit the extracted content 118 to a publisher for a variety of reasons. For example, the publisher may be the producer of a radio talk program that the user 102 listens to, and the user 102 may desire to submit the selected content to the producer for possible inclusion in a future edition of the radio talk program. Alternatively for example, the user 102 may be a member (e.g., producer, host, or staff person) of the radio talk program, and may desire to make the selected content available to other members (e.g., the producer or other hosts) of the talk program for possible inclusion in the a future edition of the radio talk program. Alternatively, for example, the publisher may maintain a web site (such as a blog) that the user 102 visits or to which the user 102 subscribes, and the user 102 may desire to submit the selected content to the publisher for possible inclusion on the web site. These are merely examples of situations in which the user 102 may submit the extracted content 118 to a publisher, and do not constitute limitations of the present invention.

As illustrated in FIG. 1A, the web client 104 includes a content extractor 116. The code associated with the bookmarklet icon 306 is one example of the content extractor 116 illustrated in FIG. 1A. When the user 102 provides the submission command 114 (such as by clicking on the bookmarklet icon 306), the content extractor 116 extracts content 118 from the news web page 110 (FIG. 2, step 204). The extracted content 118 may include any information, such as any one or combination of the following: (1) the entire news story 110 in the web page 110; (2) the content 304 selected by the user 102; (2) the URL 309 of the news web page 110; and (3) the title 308 of the news web page 110. Those having ordinary skill in the art will understand how to extract this and other kinds of content from the web page 110. Note further that the extracted content 118 may include not only content contained in the web page 110, but also other content derived from and/or related to the web page 110, such as the date and time at which the extracted content 118 was extracted, the type and version number of the web client 104, and the identity of the user 102.

The content extractor 116 transmits the extracted content 118 (e.g., over the Internet 106) to a content server 120, which stores the extracted content 118 in a content database 122 (FIG. 2, step 206). The extracted content 118 may be transmitted to the content server 120 in any of a variety of ways. For example, if the extracted content 118 includes the URL 309 and title 308 of the selected web page 110, and the content server 120 is associated with the URL www.contentserver.com, then the extracted content 118 may be appended to this content server URL to form a URL of the form www.contentserver.com?URL=xxxTITLE=yyy, where “xxx” is the URL 309 of the web page 110 and “yyy”.is the title 308 of the web page. Those having ordinary skill in the art will appreciate how to configure the content server 120 to extract the appended information from this URL and store it in the content database 122.

Although only one user 102 is shown in FIG. 1A, the system 100 may be configured to allow multiple users to submit content for storage in the content database 122 using the techniques just described. The content submitted by such multiple users is represented in FIG. 1A by extracted content 124 in the content database 122. Each unit of content 124 stored in the database 122 may be tagged with an identifier of the user who submitted such content, thereby making it possible for the content server 120 to subsequently identify the user who submitted any particular piece of content in the database 122.

Authorization to store content in the content database 122 may be controlled in any way. For example, anyone with access to the World Wide Web may be allowed to store content in the content database 122. Alternatively, for example, users may be required to register with the content server 120 before being allowed to submit content for inclusion in the content database 122. As yet another example, the system 100 may be used internally within an organization or project (such as a radio talk program), in which case the ability to add content to the content database 122 may be restricted to members of the organization or project. These are merely examples of ways in which access to the content database 122 may be controlled, and do not constitute limitations of the present invention.

Note that the selection of particular content (e.g., the selection of content 304) by the user 102 is not required. The user 102 may, for example, simply visit the web page 110 and submit the web page 110 for inclusion in the content database 122 by providing the submission command 114 (e.g., by clicking-on the bookmarklet icon 306). In response, the content extractor 116 may extract the content 118 and transmit it to the content server 120, which may store the extracted content 118 in the database 122. In such an example, the user 102 may submit content for inclusion in the content database 122 by performing a single action (e.g., a single mouse click or key press).

Before storing the extracted content 118 in the content database 122, the system 100 may allow or require the user 102 to edit the extracted content 118. For example, referring to FIG. 3B, an example of a web page 310 is shown through which the system 100 may allow the user 102 to edit the extracted content 118 before storing it in the content database 122.

The web page 310 includes a box 312 that displays the extracted content 118 and enables the user 102 to edit the extracted content 118 before storing it in the content database 122. More specifically, the box 312 displays the title 314a of the web page 110, the URL 314b of the web page 110, and text 314c that is the same as the text 304 selected (FIG. 3A) from the web page 110. In the example illustrated in FIG. 3B, all of the content 314a-c is displayed in editable text boxes. The user 102 may thereby edit any of the content 314a-c. For example, the user 102 may choose to edit the title 314a by removing the name of the web site from it, thereby leaving only the title 308 of the selected news story 140.

The user 102 may, for example, edit the synopsis 314c of the story. The system 100 may either replace the original synopsis with the edited synopsis for all users, or keep both the original synopsis and the edited synopsis. In the latter scenario, when the user 102 subsequently accesses the extracted content 118, the user 102 may be presented with the edited version of the synopsis. Other users of the system 100 who access the extracted content 118, however, may be provided with the original (unedited) version of the synopsis. This feature, if implemented, allows each user to make private changes to content that are accessible only to that user and not to other users of the system 100.

Once the user 102 has finished performing any desired editing on the content 314a-c, the user 102 may submit the resulting extracted content 118 to the content database 122 by pressing button 316.

Although not shown in FIG. 3B, the submission web page 310 may allow the user 102 to provide additional information for inclusion in the extracted content 118. For example, the web page 310 may allow the user 102 to select one or more categories (or other kinds of tags) to associate with the extracted content 118. The system 100 may, for example, provide the user 102 with a set of predetermined categories from which to choose, or may allow the user 102 to define and select additional categories.

Once the extracted content 118 has been added to the content database 122, the extracted content 124 in the database 122 is made viewable to the user 102, and optionally to multiple users of the system 100. The system 100 may, for example, impose access controls limiting the ability of particular users to access content 124 in the database 122. The system 100 may, however, allow all users of the system 100 to access the extracted content 124.

The content server 120 may, for example, transmit some or all of the extracted content 124 to the user 102 in the form of rendered extracted content 126. Referring to FIG. 3C, an example of a web page 320 is shown which displays the rendered extracted content 126 to the user 102. Assuming for purposes of example that each item in the extracted content 118 is a news story, the web page 320 shown in FIG. 3C will be referred to as the “Stories” page, because it displays content extracted from news stories selected by users of the system 100 using the techniques described above. In the example illustrated in FIG. 3C, the Stories page 320 displays a list of news story summaries 322a-c. Each of the summaries 322a-c corresponds to extracted content for one news story. For example, summary 322a may correspond to the content 118 extracted from the web page 302 shown in FIG. 3A.

The user 102 may cause the Stories page 320 to be displayed at any time. For example, web pages such as the submission web page 310 and the stories web page 320 may include buttons 318a-e which the user 102 may press to view different information within the system 100. For example, the user 102 may press the “Home” button 318a to return to a home page (not shown), such as a home page of the publication (e.g., radio talk show) for which content may be submitted using the techniques disclosed herein. Such a home page may include any content, and may, for example, serve as a landing page for prospective users, contain blogs of employees and news about the system 100, and provide a form through which users may log in to the system 100. The user 102 may press the “Submit” button 318e to display the Submission web page 310. The user 102 may press the “Stories” button 318b to view the stories page 320 (FIG. 3C). The remaining buttons 318c-d will be described below.

Although only three summaries 322a-c are shown in FIG. 3C, the Stories page 320 may display any number of summaries. Furthermore, the user 102 may be provided with the ability to sort and/or filter the content displayed in the Stories page 320, such as by title, date, category, or other criteria.

The Stories page 320, therefore, allows the user 102 to view content submitted by the user 102 and possibly by other users of the system 100. Note that additional filtering of stories may be performed as part of submitting content to the content database 122. For example, extracted content 118 being submitted to the content database 122 may be compared to existing content 124 in the database to ensure that the database 122 does not include duplicate content. Such comparison may be performed automatically by the system 100 and/or manually by a system administrator. It may be desirable and/or necessary for a system administrator to perform at least some screening for duplicate content in cases such as those in which two different URLs nonetheless reference the same content.

Furthermore, content 124 in the content database 122 may be classified as either “approved” or “yet to be approved.” The extracted content 118 may be classified as “yet to be approved” by default upon being stored in the content database 122. A system administrator (not shown) may be provided with the ability to review the extracted content in the database 122 that is “yet to be approved” and to change the status of such content to “approved.” The system 100 may display only “approved” content to the user 102 on the Stories page 320. These are merely examples of techniques that may be used in conjunction with the system 100 shown in FIG. 1A, and are not requirements of the present invention.

Story summaries 322a include corresponding “prep” buttons 324a-c. The user 102 may select the prep button for any story summary to “prep” the corresponding story (FIG. 2, step 208). For example, if the user 102, is the producer or host of a radio talk show, the user 102 may decide to prep the story corresponding to summary 322a if the user 102 considers the story worthwhile to consider for inclusion in the radio talk show. More generally, the act of “prepping” refers to flagging particular content for potential inclusion in a publication, as that term is used herein.

When the user 102 presses the prep button 324a for story summary 322a, the web client 104 may transmit a prep selection command 128 to the content server 120, indicating that the user 102 desires to prep the story corresponding to summary 322a. In response, the content server 120 may add the extracted content corresponding to summary 322a to a “prepped list” 130 for user 102 (FIG. 2, step 210). The prep selection command 128 may include an identifier of the story summary 322a that enables the content server 120 to identify the corresponding content in the extracted content 124, and either to copy that content into the user's prepped list 130, or to add a reference to that content to the user's prepped list 130.

For ease of illustration, only the single prepped list 130 for user 102 is shown in FIG. 1A. The content database 122 may, however, include a distinct prepped list for each user of the system 100. Each user may create his or her own prepped list using the techniques just described.

The user 102 may view his or her prepped list 130 by, for example, pressing the “Prepped” button 318c to view a “Prepped” web page corresponding to the user 102, an example 330 of which is shown in FIG. 3D. Upon pressing the “Prepped” button 318c, the content server 120 may use the prepped list 130 corresponding to the user 102 to produce a rendered prepped list 132 which displays the extracted content stored in or referenced by the prepped list 130.

Assume for purposes of example that the user 102 has selected the story 140 illustrated in FIG. 3A for prepping, and that the user's prepped list 130 therefore only includes extracted content 118 for that single story. As a result, the Prepped web page 330 shown in FIG. 3D displays a single story summary 332, corresponding to the web page 110. If the user 102 had selected additional stories for prepping, the Prepped web page 330 would display summaries for those additional stories. The Prepped web page 330, therefore, enables the user 102 to view only those stories that the user 102 has selected to be prepped. The system 100 may allow other users of the system 100 to view the Prepped web page 330 for the user 102, thereby enabling users to see which stories other users consider to be worthwhile considering for publication.

The web pages 320 and 330 shown in FIGS. 3C and 3D, respectively, only display summaries of stories. The user 102 may view an entire story at any time by, for example, clicking on the title of the story in a summary. For example, referring again to FIG. 3D, the user 102 may click on the story title 334, thereby causing the system 100 to display the entire corresponding story, as illustrated by web page 340 in FIG. 3E. In the particular example illustrated in FIG. 3E, the web page 340 includes a frame 342 that displays the original web page 302 submitted by the user 102 to the content database 122. Note that this frame 342 may be rendered by accessing the source web page. Alternatively, for example, the system 100 may store a copy of the source web page 110 in the extracted content 118 that is submitted to the content database 122. In such a case, the system 100 may display the copy of the web page in the frame 342 in FIG. 3E.

The web page 340 also includes a frame 344 that includes content 118 extracted from the web page 302, such as the title 314a and selected content 314c from the web page 302′. The user 102 may use the built-in print function of the web client 104 to print the complete web page 340 for further use.

Returning to the Prepped page 330 shown in FIG. 3D, the user 102 may choose to “mint” a story by clicking its “Mint” button (FIG. 2, step 212). For example, the story summary 332 shown in FIG. 3D includes a “mint” button 336. If, for example, the user 102 is the producer or host of a radio talk show, the user 102 may decide to mint the story corresponding to summary 332 if the user 102 wants to include the story on the show's web site. More generally, the act of “minting” refers to flagging particular content for actual inclusion in a publication.

When the user 102 presses the mint button 336 for story summary 332, the web client 104 may transmit a mint selection command 134 to the content server 120, indicating that the user 102 desires to mint the story corresponding to summary 332. In response, the content server 120 may add the extracted content corresponding to summary 332 to a “minted list” 136 for user 102 (FIG. 2, step 214). The mint selection command 134 may include an identifier of the story summary 332 that enables the content server 120 to identify the corresponding content in the extracted content 124, and either to copy that content into the user's minted list 136, or to add a reference to that content to the user's minted list 136.

For ease of illustration, only the single minted list 136 for user 102 is shown in FIG. 1A. The content database 122 may, however, include a distinct minted list for each user of the system 100. Each user may create his or her own minted list using the techniques just described.

The user 102 may view his or her minted list 136 by, for example, pressing the “Minted” button 318d (e.g., on the submission web page 310 shown in FIG. 3B) to view a “Minted” web page for the user 102, an example 350 of which is shown in FIG. 3F. Upon pressing the “Minted” button 318d, the content server 120 may use the minted list 136 corresponding to the user 102 to produce a rendered minted list 138 which displays the extracted content specified in the minted list 136.

Assume for purposes of example that the user 102 has selected the story 140 shown in FIG. 3A for minting, and that the user's minted list 136 therefore only includes extracted content 118 for that single story. As a result, the Minted web page 350 shown in FIG. 3F displays a single story summary 352, corresponding to the web page 110. If the user 102 had selected additional stories for minting, the Minted web page 350 would display summaries for those additional stories. The Minted web page 350, therefore, enables the user 102 to view only those stories that the user 102 has selected to be minted. The system 100 may allow other users of the system 100 to view the Minted web page 350 for the user 102, thereby enabling users to see which stories other users have selected for inclusion in a publication.

In response to the user 102 selecting a story for minting, the system 100 may also publish some or all of the user's minted list 136 (FIG. 2, step 216). The term “publish” is used broadly herein to refer, for example, to posting of information derived from the minted list 136 on a web site, or inclusion of information derived from the minted list 136 in an XML/RSS feed. For example, the system 100 may have access to or maintain a web site for each user of the system 100. Each such web site may display the stories (or summaries thereof) that have been minted by the corresponding user.

For example, if the user 102 is a producer or host of a radio talk show, the show may have a web site. Referring to FIG. 1B, a different view of the system 100b is shown, including a web site 160 associated with a radio talk show. The system 100 may automatically update the web site 160 of the talk show with summaries of minted news stories selected by the producer and/or host of the show. Each summary may include, for example, the extracted content (such as title, URL, and selected text) for the corresponding story. For example, referring to FIG. 3J, a web page 390 is shown that may be created or updated by the system 100 to include summaries 392a-c of minted stories 136. Note that the web page 390 may include other content not generated or updated by the system 100. The system 100 thereby provides the ability for a talk show, or other organization or individual, to maintain a web site that is automatically updated to reflect the minted stories 136, while maintaining the flexibility for the user 102 to design the remainder of the web site in any desired manner.

The system 100 may publish the minted list 136 in any of a variety of ways. Referring to FIG. 3G, an example is shown of an XML file 360 representing the minted list 136 for the user 102, in the case where the minted list 136 includes only the single story 140 contained in the web page 110. The XML file 360 contains a <title> element containing the title of the story 140, a <link> element 366 containing the URL of the story 140, and a <synopsis> element 368 containing a synopsis of the story 140 (such as the text 304 selected by the user 102 in the web page 302 of FIG. 3A). All of these elements 364, 366, and 368 are contained within a <story> element 370 corresponding to the single story 140 reflected in the minted stories list 136. Additional <story> elements may be added to the XML file 360 to represent additional minted stories.

File formats other than XML, such as RSS, may be used to represent the minted list 136. Furthermore, the user 102 may be provided with the ability to publish the minted list 136 automatically to multiple feeds, which may be accessible at different URLs and use different feed formats. The system 100 may generate all of these feeds using the minted list 136 and the content 124 stored in the content database 122.

Referring to FIG. 3H, an example of an HTML file 370 is shown which may be generated by the system 100 to represent the minted list 136. The HTML file 370 includes the title and summary of each story in the minted list 136. The title is contained within an HTML <DIV> element 372, which includes a hyperlink to the original web page 110 from which the story was extracted. This makes it possible for users to use the title to browse to the web page 110 from which the story originated. The summary is contained within another HTML <DIV> element 374.

The system 100 may include the HTML file 370 automatically in the radio talk show web site 160 (such as the web page 390 shown in FIG. 3J), or otherwise provide such source code to the radio talk show. The talk show's web site may thereby provide a summary of each minted story, which readers (e.g., radio show listeners) may read and use to browse to the original version of each story.

As mentioned previously, a radio talk show is used herein merely as an example of an organization/project that may make use of the system 100. More generally, the techniques disclosed herein may be applied to publish content for any kind of individual, project, or organization.

Referring to FIG. 3I, an example of another HTML file 380 containing AJAX code is shown which may be generated by the system 100 to represent the minted list 136. Unlike the HTML code 370 shown in FIG. 3H, the HTML AJAX code 380 shown in FIG. 3I does not directly include elements of the minted list 136 such as the titles and summaries. Instead, when a user 152 (such as a radio show listener) uses web client 156 to browse 154 to the radio show web site 160, the AJAX code 380 causes the web client 156 to dynamically request the required content in the minted list 136 from the content server 120 and then to insert the requested content 166 into the web page 160 (e.g., the web page 390 shown in FIG. 3J) to produce a rendered web page 164 displaying some or all of the content in the minted list 136. The AJAX code, in other words, performs the function of dynamically linking to the minted list 136, and therefore is represented in FIG. 1B as links to minted content 162.

The use of AJAX code such as the code 380 shown in FIG. 3I has a variety of benefits. For example, it shifts the burden of retrieving the stories referenced by the minted list 136 from the radio show web server 158 to the listener's web client 156. To provide dynamically-updateable content on the radio show's web site 160, the web site 160 need only be modified once to include the appropriate links 162 (e.g., AJAX code). Once such links are installed at the web site 160, the appropriate minted content is dynamically pulled into the web page 164 by the listener's web client 156 from content server 120 and then displayed to the listener 152, without the need for intervention by the radio show web server 158 or the radio show's webmaster.

Furthermore, the use of code such as that shown in FIG. 3I enables the content server 120 to track how frequently each unit of content in the minted list 136 is viewed, because each request to access the minted list 136 goes through the content server 120. Consider, for example, the aspect of the system 100c shown in FIG. 1C, in which the user 152 (e.g., radio show listener) clicks 166 on a link to content in the minted list 136. Because the link points to the content server 120, the web client 156 transmits a request 172 to the content server 120 for the linked content. The content server 120 provides the linked content 174, either by extracting it from the content database 122 (if the content database 122 contains a copy of the requested content) or by redirecting the user to the original source over the Internet 106. The web client 156 then renders and displays the linked content to the user 152 in a web page 170. All requests by the user 152 for minted content 136 (such as request 168) may be tracked by the content server 120 because all such requests go through the content server 120.

The content server 120 may also control the content that is transmitted to the web client 156. The content server 120 may, for example, dynamically insert advertisements into the responses to the AJAX code 380, thereby pushing such content to the user 152 even if the radio show has not modified its web site 160. These benefits are obtained in a manner that is supported by most web browsers and that produces web pages that look the same as, or substantially similar to, web pages produced using non-AJAX HTML.

Considering again the example in which the minted list 136 represents stories to be included on the radio talk show web site 160, the news feed (such as the XML file 360 shown in FIG. 3G) generated from the minted list 136 may be published in ways other than including the list 136 in the web site 160. For example, the system 100 may associate a news feed URL with the minted list 136 and may provide a link to that URL for inclusion on the web site 160 (such as the web site 390 shown in FIG. 3J). An icon that corresponds to the news feed URL may be displayed on the web site 160. The user 152 may subscribe to the news feed by clicking on the icon. Software for establishing and maintaining such subscriptions is widely available, and is often integrated into web clients themselves. A user who has subscribed to the minted list news feed in this or another manner may thereby receive new content that is added to the minted list 136.

In the case where the user 102 is a producer or host of a radio talk show, it may be desirable to enable listeners of the show to see the stories reflected in the minted list 136 only by visiting the web site 160 of the radio talk show, and/or by subscribing to the news feed corresponding to the minted list 136. The system 100 may, however, provide a link or other mechanism that makes it possible for listeners and other external users to incorporate the minted list 136 into their own web sites. This would allow, for example, a listener to provide a section on his or her web site entitled, “Here are the top five stories from my favorite radio show, ‘Frank's Place,’” followed by a list of story summaries (such as the summaries 392a-c shown in FIG. 3J). Allowing listeners to provide such content directly in their own sites could drive additional traffic to the radio show's web site.

As mentioned above, internal users of the system 100 (such as employees of a radio talk show) may be given the ability to both prep and mint stories. The system 100 may provide certain users, such as listeners or other external users, with the ability only to prep but not mint stories. Such users may, for example, be provided with a link that can be stored as a bookmarklet in their web browsers. Such a link may point to “prepping” code. If a user browses to a news story that he or she believes may be of interest to the radio show, the user may click on the “prep” bookmarklet, thereby causing content to be extracted for that story (as described above with respect to the extracted content 118) and transmitted to the content server 120. The producer, host, or other member of the radio show may then refer stories submitted by listeners and decide whether to “mint” them. This functionality would provide the talk show with the ability to take advantage of suggestions provided by its listeners as their scour the Web for relevant stories.

Among the advantages of the invention are one or more of the following. The techniques disclosed herein enable content to be published quickly and easily to the web site of an organization or project, such as a radio talk show, without requiring the involvement of the webmaster of that project. The published content is hosted on and served by the content server 120, which may be maintained by an external entity that specializes in providing such online content. Such a service may be particularly valuable in certain contexts, such as radio talk shows, where it is essential that online content be up-to-date, because the talk show webmaster may not be able to manually update the talk show's web site with rapidly-developing news stories quickly enough. The system 100 illustrated in FIG. 1A allows the talk show's web site to be updated essentially immediately after users “mint” stories.

Furthermore, hosting content on the content server 120 may enable such content to be served more robustly than if it were served directly from a radio talk show's web site. By specializing in providing online content and by hosting a large volume of such content, the entity that maintains the content server 120 may leverage economies of scale to provide high bandwidth connections, data backup and redundancy, and other features that would not be economical for the radio talk show to provide directly for content hosted on its web site. The radio talk show benefits by providing the appearance to its users that it is hosting the content on its web site, but at a higher quality and lower cost than would be possible if the talk show hosted such content directly.

If the system 100 copies content (such as the news story 140 in the web page 110) to the content server 120 rather than linking to it, the system 100 may provide the additional benefit of providing access to such content even if the original content (e.g., the original web page 110) changes, is removed, or becomes temporarily unavailable.

In addition to copying content to the content server 120, the content server 120 may maintain multiple copies of the meta-data (e.g., title, URL, and synopsis) associated with a particular unit of content (such as a particular news story). Each copy of the meta-data may be associated with a different user. For example, the system 100 may create a new copy of the meta-data associated with news story 140 when a user begins to edit the meta-data for news story 140 for the first time. Any changes made by the user are applied to the user's personal copy of the meta-data. Similarly, changes made by other users to the meta-data for the same news story may be applied to their personal copies of the meta-data. Certain meta-data, however, such as user comments and ratings, may be shared among all copies of the content. The system 100 may be configured to provide any combination of personal and shared meta-data for each unit of content stored in the content database 122.

Whether or not content is copied to the content server 120, the system 100 may provide customers (such as a radio talk show) with links back to the content server 120 rather than to the original content (e.g., the news story 140). When a user clicks on otherwise selects such a link, the content server 120 may serve the request, either by providing content directly from the content database 122 or by providing access to the original content (e.g., the news story 140). In either case, the system 100 is able to generate and maintain statistics, such as the frequency of use of content within the database 122. The system 100 may provide this information to its customers (such as radio talk shows) to inform them of the content that has been viewed most frequently, most recently, by certain classes of users, etc.

A radio talk show or other customer of the system 100 may also use the system 100 to provide additional branding channels. The ability to provide branded summaries of news stories on other web sites, as shown in FIG. 3J, is an example of this. As another example, a talk show may send a daily email to all of its subscribers containing “stories of the day.”

Furthermore, the use of an online prep service, such as the system 100 illustrated in FIG. 1A, eliminates the need to use multiple stacks of paper to “prep” a talk show. Some or all of the prepping process may be moved online to a common web site which all members may access and simultaneously participate in collaboratively. This represents an improvement over the current paper-based system, and even over existing electronic systems based on an emailed prep or a prep posted to a non-interactive web page.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

For example, elements and components described herein may be further divided into additional components or joined together to form fewer components for performing the same functions. The functions performed by the content server 120, for example, may be performed by multiple servers rather than a single server. Similarly, the data stored in the content database 122 may be stored in multiple databases. Furthermore, terms such as “client,” “server,” and “database” refer to examples of technologies that may be used to implement particular aspects of the present invention, but do not represent limitations of the present invention.

The description above refers to the title, URL, and synopsis of the news story 140 (FIG. 1A) being stored in the content server 120. Such data elements are merely examples of the extracted content 118 and do not constitute limitations of the present invention. Furthermore, information in addition to that extracted from the news story 140, such as information provided directly by the user (such as comments on the news story) may also be stored in the content database 122.

Although certain examples described herein involve the use of bookmarklets to perform certain functions, such functions may be performed using technologies other than bookmarklets. Similarly, references to web-related technologies such as HTML, AJAX, XML, and RSS are provided merely for purposes of example and do not constitute limitations of the present invention.

The description herein refers to “publishing” the minted list 136 and to “publications” that may include content from the minted list 136. The term “publishing” is used broadly herein to refer not merely to traditional print publishing, but also to electronic publishing, such as storing the minted list on a tangible electronic medium or posting the minted list 136 to a web site, and to performances, such as including stories from the minted list 136 in a radio talk program or a television program. The term “publication,” therefore, is used herein to refer not merely to a printed publication, but to any electronic document or collection thereof, and to electronic transmissions (such as radio broadcasts and transmission of XML/RSS news feeds).

In the particular example illustrated in FIG. 1A, the prepped list 130 and minted list 136 are associated with the user 102. Note, however, that the prepped and minted lists may-be associated with a group of users defined in any way. For example, the prepped and minted lists may be associated with a group of users affiliated with a particular radio talk show, such as all of the members of the staff of that show.. Associating a prepped list and minted list with a group of users allows those users to collaborate on the production process.

The various lists described herein, such as the “prepped list” and “minted list,” need not be lists or summaries of stories. The term “prepped list,” for example, may refer to a collection of (physical or electronic) copies of stories themselves, rather than merely summaries of or links to them. Such copies may include audio in the case, for example, of stories originally broadcast on television or radio.

The features disclosed herein may be combined with other features of an electronic publishing system. For example, the system 100 may enable users to provide and view comments on individual stories in the content database 122. The system 100 may also enable internal and/or external users of the system 100 to rate individual stories in the content database 122.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk. (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) receiving an indication of a single action performed by a first user to identify an electronic document; and
(B) in response to receiving the indication of the single action, storing information derived from the electronic document in a document repository.

2. The method of claim 1, wherein (B) comprises transmitting the derived information over a network to the document repository.

3. The method of claim 1, further comprising:
(C) displaying at least some of the derived information to a second user.

4. The method of claim 3, wherein the first user and the second user are a single user.

5. The method of claim 1, wherein the single action is a single mouse click.

6. The method of claim 1, wherein the single action selects a bookmarklet.

7. The method of claim 1, wherein the electronic document comprises a web page.

8. The method of claim 1, wherein (B) comprises:
(B) (1) copying information from the electronic document; and
(B) (2) storing the copied information in the document repository.

9. The method of claim 1, wherein (B) comprises storing a reference to at least part of the electronic document in the document repository.

10. A computer-implemented apparatus comprising:
reception means for receiving an indication of a single action performed by a first user to identify an electronic document; and
storage means for storing, in response to receiving the indication of the single action, information derived from the electronic document in a document repository.

11. The apparatus of claim 10, wherein the storage means comprises means for transmitting the derived information over a network to the document repository.

12. The apparatus of claim 10, further comprising:
means for displaying at least some of the derived information to a second user.

13. A computer-implemented method comprising:
(A) receiving an indication of a single action performed by a first user to identify an electronic document; and
(B) in response to receiving the indication of the single action, generating a first web page including information derived from the electronic document.

14. The method of claim 13, wherein (B) comprises transmitting the derived information over a network to a node on the network at which the first web page is stored.

15. The method of claim 13, further comprising:
(C) rendering the first web page, including at least some of the derived information, for a second user.

16. The method of claim 15, wherein the first user and the second user are a single user.

17. The method of claim 13, wherein the single action is a single mouse click.

18. The method of claim 13, wherein the single action selects a bookmarklet.

19. The method of claim 13, wherein the electronic document comprises a web page.

20. The method of claim 13, wherein the electronic document comprises an electronic news feed.

21. The method of claim 13, wherein (B) comprises:
(B) (1) copying information from the electronic document; and
(B) (2) including the copied information in the first web page.

22. A computer-implemented apparatus comprising:
reception means for receiving an indication of a single action performed by a first user to identify an electronic document; and
generation means for generating, in response to receiving the indication of the single action, a first web page including information derived from the electronic document.

23. The apparatus of claim 22, wherein the generation means comprises means for transmitting the derived information over a network to a node on the network at which the first web page is stored.

24. The apparatus of claim 22, further comprising:
means for rendering the first web page, including at least some of the derived information, for a second user.

25. The apparatus of claim 24, wherein the first user and the second user are a single user.

26. A computer-implemented method comprising:
(A) receiving an input from a first user to identify content in a source web page;
(B) in response to receiving the input, storing the identified web page content in a document repository; and
(C) making the identified web page content accessible at an Internet address.

27. The method of claim 26, wherein (C) comprises posting the identified web page content to a destination web page accessible at the Internet address.

28. The method of claim 26, wherein (C) comprises making the identified web page content accessible through a news feed served at the Internet address.

29. The method of claim 26, wherein (C) comprises transmitting the identified web page content over a network to the document repository.

30. A computer-implemented apparatus comprising:
reception means for receiving an input from a first user to identify content in a source web page;
storage means for storing, in response to receiving the input, the identified web page content in a document repository; and
accessibility means for making the identified web page content accessible at an Internet address.

31. The apparatus of claim 30, wherein the accessibility means comprises means for posting the identified web page content to a destination web page accessible at the Internet address.

32. A computer-implemented method comprising:
(A) making a content unit available to a plurality of users over a computer network, the content unit including shared content, first private content for a first one of the plurality of users, and second private content for a second one of the plurality of users;
(B) receiving first input from the first one of the plurality of users, the first input indicating a modification to the first private content;
(C) modifying the first private content in response to the first input;
(D) receiving second input from the second one of the plurality of users requesting access to the content unit; and
(E) in response to the second input, providing the second user with access to the shared content and the second private content but not the first private content.

33. The method of claim 32, further comprising:
(F) receiving third input from the second one of the plurality of users, the third input indicating a modification to the second private content;
(G) modifying the second private content in response to the third input;
(H) receiving fourth input from the first one of the plurality of users to access the content unit; and
(I) in response to the fourth input, providing the first user with the shared content and the first private content but not the second private content.

34. The method of claim 32, further comprising:
(F) receiving third input from the first one of the plurality of users, the third input indicating a modification to the shared content;
(G) modifying the shared content in response to the third input;
(H) receiving fourth input from the second one of the plurality of users requesting access to the content unit; and
(I) in response to the fourth input, providing the second user with access to the shared content and the second private content but not the first private content.

35. A computer-implemented apparatus comprising:
publishing means for making a content unit available to a plurality of users over a computer network, the content unit including shared content, first private content for a first one of the plurality of users, and second private content for a second one of the plurality of users;
first input means for receiving first input from the first one of the plurality of users, the first input indicating a modification to the first private content;
modification means for modifying the first private content in response to the first input;
second input means for receiving second input from the second one of the plurality of users requesting access to the content unit; and
accessibility means for providing, in response to the second input, the second user with access to the shared content and the second private content but not the first private content.

36. A computer-implemented method comprising:
(A) making a content unit available to a plurality of users over a computer network, the content unit including shared content and non-shared content;
(B) receiving first input from the first one of the plurality of users, the first input indicating a first modification to the non-shared content;
(C) in response to the first input:
(1) copying the non-shared content to produce first private content; and
(2) modifying the first private content;
(D) receiving second input from the second one of the plurality of users requesting access the content unit; and
(E) in response to the second input, providing the second user with access to the shared content and the non-shared content but not the first private content.

37. The method of claim 36, further comprising:
(F) receiving third input from the second one of the plurality of users, the third input indicating a second modification to the non-shared content;
(G) in response to the third input:
(1) copying the non-shared content to produce second private content; and
(2) modifying the second private content;
(H) receiving fourth input from the first one of the plurality of users to access the content unit; and
(I) in response to the fourth input, providing the first user with access to the shared content and the first private content but not the second private content.

38. The method of claim 36, further comprising:
(F) receiving third input from the first one of the plurality of users, the third input indicating a modification to the shared content;
(G) modifying the shared content in response to the third input;
(H) receiving fourth input from the second one of the plurality of users requesting access to the content unit; and
(I) in response to the fourth input, providing the second user with access to the shared content and the non-shared content but not the first private content.

39. A computer-implemented apparatus comprising:
publication means for making a content unit available to a plurality of users over a computer network, the content unit including shared content and non-shared content;
first input means for receiving first input from the first one of the plurality of users, the first input indicating a first modification to the non-shared content;
copying means for copying the non-shared content to produce first private content in response to the first input; and
modification means for modifying the first private content in response to the first input;
second input means for receiving second input from the second one of the plurality of users requesting access the content unit; and
accessibility means for providing, in response to the second input, the second user with access to the shared content and the non-shared content but not the first private content.
